(19) United States
(12) Patent Application Publication
(10) Pub. No.: US 2023/0095210 A1
(43) Pub. Date: Mar. 30, 2023

(54) PERMANENT MAGNET AND DEVICE

(71) Applicant: TOKIN Corporation, Sendai-shi (JP)

(72) Inventors: Hiroaki MACHIDA, Sendai-shi (JP); Teruhiko FUJIWARA, Sensdai-shi (JP); Hirokazu MAKUTA, Sendai-shi (JP)

(21) Appl. No.: 17/935,463

(22) Filed: Sep. 26, 2022

(30) Foreign Application Priority Data
Sep. 29, 2021 (JP) 2021-159333

(51) Int. Cl. H01F 7/02; H01F 1/055

(52) U.S. Cl. CPC H01F 7/021; H01F 1/0557; H01F 1/0551

(57) ABSTRACT

A permanent magnet having excellent magnetic properties, and a device including such a permanent magnet are provided. A permanent magnet consists of a sintered compact having a composition consisting of, in a mass percentage composition, R: 23 to 27% (R is a rare-earth element including at least Sm); Fe: 22 to 27%; Mn: 0.01 to 2.5%; and a remainder consisting of Co and unavoidable impurities, in which the sintered compact contains a plurality of crystal grains and grain boundaries, an average crystal grain size (A. G.) of the crystal grains is equal to or larger than 100 μm, and a coefficient of variation (C. V.) of crystal grain sizes is equal to or smaller than 0.60.

### CROSS-REFERENCE TO RELATED APPLICATION

The present application claims priority to Japanese Patent Application No. 2021-159333, filed on Sep. 29, 2021. The entire contents of the above-listed application are hereby incorporated by reference for all purposes.

### BACKGROUND

The present disclosure relates to a permanent magnet and a device.

As a type of a permanent magnet, a rare-earth cobalt permanent magnet such as a samarium-cobalt magnet has been known. Regarding rare-earth cobalt permanent magnets, studies regarding those that contain Fe, Cu, Zr or the like have been conducted from various aspects, for example, for improving their magnetic properties.

For example, Japanese Unexamined Patent Application Publication No. 2018-100450, International Patent Publication No. WO2016/151621, and Japanese Unexamined Patent Application Publication No. 2017-168827 each disclose a specific permanent magnet containing specific amounts of a rare-earth element and at least one element selected from Fe, Cu, Co, Zr, Ti and Hf, and having a structure containing crystal gains consisting of a main phase containing a Th₂Zn₁₇-type crystal phase, and crystal grain boundaries between the crystal grains.

Regarding the samarium-cobalt magnet, it has been desired to improve its coercive force even further and to achieve satisfactory squareness.

### SUMMARY

An object of the present disclosure is to provide a permanent magnet having excellent magnetic properties, and a device including such a permanent magnet.

A permanent magnet according to the present disclosure consists of a sintered compact having a composition consisting of, in a mass percentage composition, R: 23 to 27% (R is a rare-earth element including at least Sm); Fe: 22 to 27%; Mn: 0.01 to 2.5%; and a remainder consisting of Co and unavoidable impurities, in which

the sintered compact contains a plurality of crystal grains and grain boundaries, an average crystal grain size (A. G.) of the crystal grains is equal to or larger than 100 μm, and a coefficient of variation (C. V.) of crystal grain sizes is equal to or smaller than 0.60.

In an embodiment, the above-described permanent magnet further contains, in the mass percentage composition, Cu: 4.0 to 5.0%, and Zr: 1.7 to 2.5%.

In an embodiment of the above-described permanent magnet, when a coercive force is represented by Hcj and a magnitude of a reverse magnetic field when a residual magnetic flux density (Br) is 90% is represented by Hk, a squareness ratio (Hk/Hcj) is equal to or higher than 65% under conditions that: a density of the sintered compact is equal to or larger than 8.25 g/cm³; the residual magnetic flux density (Br) is equal to or larger than 1.16 T; and a maximum energy product (BH)m is equal to or larger than 260 kJ/m³, and

when a temperature coefficient of the residual magnetic flux density (Br) is represented by α and a temperature coefficient of the coercive force (Hcj) is represented by β, they satisfy conditions “α≤0.050%/K” and “β≤0.35%/K” in a temperature range of 25 to 200° C.

Further, a device according to the present disclosure includes the above-described permanent magnet.

According to the present disclosure, it is possible to provide a permanent magnet having excellent magnetic properties, and a device including such a permanent magnet.

The above and other objects and features of the present disclosure will become more fully understood from the detailed description given hereinbelow and the accompanying drawings which are given by way of illustration only, and thus are not to be considered as limiting the present disclosure.

### BRIEF DESCRIPTION OF THE FIGURES

FIG. 1 is an optical microscope image showing an example of a polished surface of a permanent magnet according to the present disclosure.

### DETAILED DESCRIPTION

A permanent magnet and a device according to the present disclosure will be described hereinafter.

Note that a numerical range such as “n-m” or “n to m” (i.e., “from n to m”) includes the lower and upper limit values, unless otherwise specified.

### Permanent Magnet

A permanent magnet according to the present disclosure consists of a sintered compact having a composition consisting of, in a mass percentage composition, R: 23 to 27% (R is a rare-earth element including at least Sm); Fe: 22 to 27%; Mn: 0.01 to 2.5%; and a remainder consisting of Co and unavoidable impurities, in which

the sintered compact contains a plurality of crystal grains and grain boundaries, an average crystal grain size (A. G.) of the crystal grains is equal to or larger than 100 μm, and a coefficient of variation (C. V.) of crystal grain sizes is equal to or smaller than 0.60.

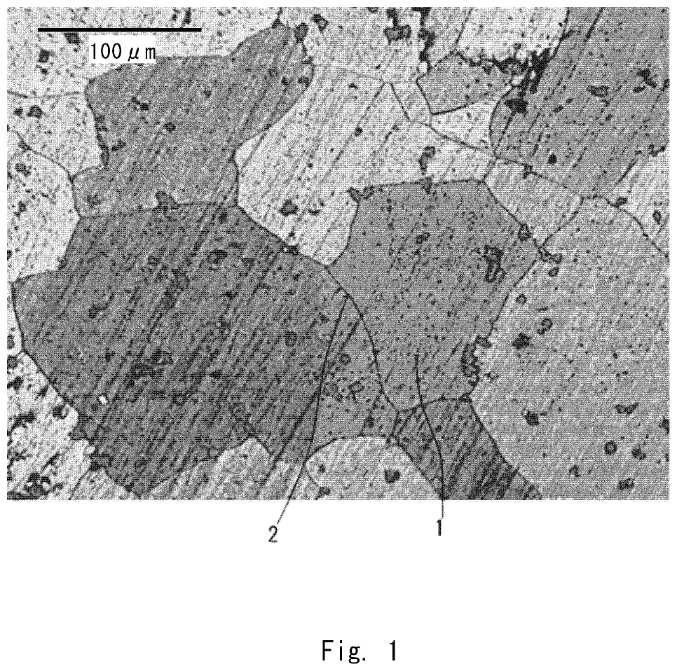

The permanent magnet according to the present disclosure (hereinafter also referred to simply as the permanent magnet) consists of a sintered compact having the above-described specific composition, and as shown in an example in FIG. 1, is a permanent magnet containing crystal grains 1 in each of which a crystal phase having a Th₂Zn₁₇-type structure is a main phase, and grain boundaries 2 each of which serves as a boundary between neighboring crystal grains 1.

When a reverse magnetic field is applied to the permanent magnet, reverse magnetic domains are generated from the grain boundaries 2. Since the average crystal grain size (A. G.) of the crystal grains of the permanent magnet is 100 μm or larger, the number of grain boundaries 2 contained in the sintered compact can be reduced. Further, since the coefficient of variation (C. V.) of the crystal grain sizes is 0.60 or smaller, the grain sizes of the crystal grains 1 are relatively uniform, and the number of crystal grains having a small size (i.e., grain boundaries are dense) is reduced. As a result, the permanent magnet according to the present disclosure is characterized in that: the generation of reverse magnetic domains is suppressed; the squareness is satisfactory; and high residual magnetization is obtained even when a large reverse magnetic field (e.g., 10 kOe or larger) is applied.

Note that, by processing a raw material having the above-described specific composition containing 0.01 to 2.5% of Mn by a method described later, it is possible to manufacture a permanent magnet of which the average crystal grain size (A. G.) of crystal gains is 100 μm or larger, and the coefficient of variation (C. V.) of crystal grain sizes is 0.6 or smaller.

A method for measuring the average crystal grain size (A. G.) and the coefficient of variation (C. V.) of crystal grains of the permanent magnet according to the present disclosure will be described.

Firstly, a permanent magnet to be measured is polished with water-resistant abrasive paper. Regarding the water-resistant abrasive paper, coarse abrasive paper is used at first, and then it is repeatedly replaced by finer one. After being polished by a plurality of pieces of water-resistant abrasive paper, the permanent magnet is mirror-polished by using a buffing machine or the like. Etching of the mirror-polished permanent magnet is carried out by submerging the permanent magnet in an acid solvent. In this process, since the grain boundaries 2 are corroded faster than the crystal grains 1 are, the grain boundaries appear clearly, thus making it possible to observe each crystal grain clearly. Next, the permanent magnet is washed with pure water or the like and then dried. It is possible to observe crystal grains by observing the processed surface of the obtained permanent magnet with an optical microscope.

In the present disclosure, the maximum Feret diameter of crystal grains is used as the grain size of the crystal grains. The Feret diameter is defined as a distance between two parallel lines located on both sides of a crystal grain, and in the present disclosure, the maximum value of such Feret diameters is used as the grain size of crystal grains. Note that it is possible to measure the grain size of crystal grains more accurately by using image processing software.

The grain sizes of crystal grains contained in a measurement area of 500 μm×500 μm are obtained (i.e., measured), and the average crystal grain size (A. G.) and the coefficient of variation (C. V.) of the crystal grains are calculated from these values.

The average crystal grain size (A. G.) may be 100 μm or larger, or 120 μm or larger. Further, although there is no particular limit on the upper limit of the average crystal grain size, the average crystal grain size is typically 1,000 μm or smaller, or 500 μm or smaller.

Further, the coefficient of variation (C. V.) may be 0.6 or smaller, or 0.5 or smaller.

The permanent magnet according to the present disclosure has a composition consisting of, in a mass percentage composition, R: 23 to 27% (R is a rare-earth element including at least Sm); Fe: 22 to 27%; Mn: 0.01 to 2.5%; and a remainder consisting of Co and unavoidable impurities. The permanent magnet has the above-described composition, and by combining it with a manufacturing method described later, a sintered compact containing crystal grains having relatively large and uniform grain sizes can be easily obtained, thus making it possible to obtain a permanent magnet having excellent magnetic properties.

In this embodiment, the term “rare-earth element R” is a general term for Sc, Y, and lanthanoids (elements having atomic numbers 57 to 71). The permanent magnet contains at least Sm as the rare-earth element R. As the rare-earth element R, only Sm may be used, or a combination of Sm and at least one other rare-earth element may be used. As the other rare-earth elements, Pr, Nd, Ce and La may be used in view of the magnetic properties. Further, in view of the magnetic properties, the content of Sm may be 80 mass % or larger, or 90 mass % or larger, or 95 mass % or larger based on the total amount of the rare-earth elements R.

The permanent magnet contains, in a mass percentage, 23 to 27% of a rare-earth element(s) R. By containing the rare-earth element(s) in the aforementioned ratio, it is possible to obtain a permanent magnet having high magnetic anisotropy and a high coercive force. In particular, the content of the rare-earth element(s) R may be 23.5 to 26.5% so that the magnetic properties are improved.

This permanent magnet according to the present disclosure contains 22 to 27% of Fe. The saturation magnetization is improved by containing 22% of Fe or larger. Further, by adjusting the content of Fe to 27% or smaller, the permanent magnet has a high coercive force. The content of Fe may be 22.5 to 26.5% so that the magnetic properties are improved.

This permanent magnet contains 0.01 to 2.5% of Mn. By containing 0.01% of Mn or larger, it becomes easy to obtain a sintered compact having relatively large and uniform grain sizes. On the other hand, when the content of Mn exceeds 2.5%, the grain sizes tend to become smaller instead of becoming larger. In particular, the content of Mn may be 0.05 to 1.5% in view of the magnetic properties.

It is presumed that, by containing 0.01% of Mn or larger, the melting point is lowered, so that the liquid phase appears more during the sintering and the crystal grain size increases. Further, there is a possibility that the grain boundaries are un-magnetized due to Mn, so that it is presumed that the generation of reverse magnetic domains at the grain boundaries is suppressed.

In some embodiments, the permanent magnet further contains Cu: 4.0 to 5.0%, and Zr: 1.7 to 2.5%.

By containing 4.0% of Cu or larger, the permanent magnet becomes one having a high coercive force. Further, by adjusting the content of Cu to 5.0% or smaller, the deterioration of the magnetization is suppressed. The content of Cu may be 4.0 to 4.7% so that the magnetic properties are improved.

Further, by containing 1.7 to 2.5% of Zr, a permanent magnet having a high maximum energy product (BH)m, which is the maximum magnetostatic energy that the magnet can hold, is obtained. The content of Zr may be 1.9% to 2.3% so that the magnetic properties are improved.

Further, the remainder of the permanent magnet according to the present disclosure consists of Co (cobalt) and unavoidable impurities. By containing Co, the thermal stability of the permanent magnet is improved. On the other hand, when the content of Co is too large, the content of Fe is relatively reduced. The content of Co may be 36 to 54.99%, or 40.00 to 50.00%.

The unavoidable impurities are elements that are unavoidably mixed in the permanent magnet from the raw material or during the manufacturing process. Examples of unavoidable impurities include, but are not limited to, C, N, P, S, Al, Ti, Cr, Ni, Hf, Sn and W. In the permanent magnet according to the present disclosure, the total ratio of unavoidable impurities is, in a mass percentage, or 5 mass % or lower, or 1 mass % or lower, or 0.1 mass % or lower based on the total amount of the permanent magnet.

The content ratio of each of the elements contained in the permanent magnet can be measured, for example, by using energy dispersive X-ray spectroscopy (EDX).

In the permanent magnet according to the present disclosure, the crystal grain has, as a main phase, a crystal phase having a Th₂Zn₁₇-type structure (hereinafter also referred to as a 2-17 phase). The Th₂Zn₁₇-type structure is a crystal structure having an R-3m-type space group. In the permanent magnet according to the present disclosure, in general, the Th part is occupied by a rare-earth element and Zr, and the Zn part is occupied by Co, Cu, Fe and Zr. Further, in the permanent magnet, the grain boundary has a crystal phase having an RCo₅-type structure (hereinafter also referred to as a 1-5 phase). Note that, in the 1-5 phase, in general, the R part is occupied by a rare-earth element and Zr, and the Co part is occupied by Co, Cu and Fe. Further, the permanent magnet may contain a crystal phase having a TbCu₇-type structure (hereinafter also referred to as a 1-7 phase). In the 1-7 phase, in general, the Tb part is occupied by a rare-earth element and Zr, and the Cu part is occupied by Co, Cu and Fe. The crystal structure can be determined by an X-ray diffraction method.

The permanent magnet according to the present disclosure can be densified so that excellent magnetic properties such as an excellent residual magnetic flux density and excellent squareness are obtained. Specifically, the density of the permanent magnet (the density of the sintered compact) may be 8.25 g/cm³ or higher. Further, although there is no particular limit on the upper limit of the density, because of the composition of the permanent magnet, the density is typically 8.45 g/cm³ or smaller. Note that the density of the permanent magnet may be increased by reducing the ratio of the presence of pores (voids), and the above-described density can be achieved by a manufacturing method described later.

In the permanent magnet according to the present disclosure, since the generation of reverse magnetic domains is suppressed as described above, it is possible to, for example, achieve a residual magnetic flux density (Br) of 1.16 T or higher. Note that the residual magnetic flux density is an amount of magnetization per unit area that remains when, after the sintered compact is completely magnetized by applying an external magnetic field thereto, the external magnetic field is returned to zero.

Further, in the permanent magnet, it is possible to achieve a maximum energy product (BH)m of 260 kJ/m³ or larger, which is the maximum magnetostatic energy that the permanent magnet can hold.

Further, in the permanent magnet according to the present disclosure, since the generation of reverse magnetic domains are suppressed, a high squareness ratio can be obtained. Specifically, it is possible to obtain a permanent magnet of which a squareness ratio expressed as (Hk/Hcj) of the magnitude (Hk) of the reverse magnetic field in a state in which the residual magnetic flux density (Br) is 90% to the coercive force (Hcj) is 65% or larger. Note that the coercive force (Hcj) is a physical quantity indicating the magnitude of a magnetic field that is required, in order to demagnetize a material magnetized in a certain direction, to be applied to the material in a direction opposite to the certain direction.

Further, in the permanent magnet according to the present disclosure, changes in the magnetic properties caused by changes in the temperature can be suppressed. For example, when the temperature coefficient of the residual magnetic flux density (Br) is represented by α, it is possible to achieve a condition “α≤0.050%/K” in a temperature range of 25 to 200° C.

Further, for example, when the temperature coefficient of the coercive force (Hcj) is represented by β, it is possible to achieve a condition “β≤0.35%/K” in the temperature range of 25 to 200° C.

Note that the temperature coefficient is a coefficient indicating an amount of a change of Br or Hcj with respect to a temperature change of 1° C. Further, they indicate that the smaller the values of α and β are, the more the changes in the magnetic properties with respect to the changes in the temperature are suppressed.

Note that various magnetic properties can be measured by processing the permanent magnet into a certain shape and by using a B-H tracer.

When a DC (Direct Current) B-H tracer is used, the permanent magnet is magnetized by applying a magnetic field about 3 to 4 times higher than the predicted Hcj, and then the properties and the like are measured according to the method of use of the apparatus (i.e., the tracer). When a pulse-type B-H tracer is used, the permanent magnet does not need to be magnetized and measurement is carried out according to the method of use of the apparatus (i.e., the tracer).

For the measurement of the temperature coefficient(s), a heater is used in or a hot inert gas is passed through a place where the sample of the B-H tracer is placed, so that the sample is warmed to a predetermined temperature, and then the measurement is carried out in a manner similar to the above-described method.

As described above, as an example, in the permanent magnet according to the present disclosure, the following excellent magnetic properties can be achieved. That is, when a coercive force is represented by Hcj and a magnitude of a reverse magnetic field when a residual magnetic flux density (Br) is 90% is represented by Hk, a squareness ratio (Hk/Hcj) is equal to or higher than 65% under conditions that: a density of the sintered compact is equal to or larger than 8.25 g/cm³; the residual magnetic flux density (Br) is equal to or larger than 1.16 T; and a maximum energy product (BH)m is equal to or larger than 260 kJ/m³; and

when a temperature coefficient of the residual magnetic flux density (Br) is represented by α and a temperature coefficient of the coercive force (Hcj) is represented by β, they satisfy conditions “α≤0.050%/K” and “β≤0.35%/K” in a temperature range of 25 to 200° C.

### Method for Manufacturing Permanent Magnet

The above-described permanent magnet can be obtained by preparing an alloy containing Mn, and adjusting mainly heat treatment conditions.

The manufacturing method will be described hereinafter in a concrete manner by using an example.

Firstly, an alloy consisting of, in a mass percentage composition, a rare-earth element(s) R: 23 to 27%; Fe: 22 to 27%; Mn: 0.01 to 2.5%; and a remainder consisting of Co and unavoidable impurities is prepared. Regarding the method for preparing the alloy, the alloy may be prepared by obtaining a commercially available alloy having a desired composition, or may be prepared by blending aforementioned elements so that the blend has a desired composition.

A specific example of the blending of the elements will be described hereinafter, but the present disclosure is not limited to this example method.

Firstly, a desired rare-earth element(s), each of metal elements of Fe, Mn and Co, and a base alloy are prepared as raw materials. The base alloy may be one having a composition having a low eutectic temperature because, by doing so, it is easy to make the composition of the obtained alloy homogeneous. In the present disclosure, FeZr or CuZr may be selected and used as the base alloy. As an example of FeZr, one containing about 20% of Fe and about 80% of Zr is suitable. Further, as an example of CuZr, one containing about 50% of Cu and 50% of Zr is suitable.

It is possible to obtain a homogeneous alloy by blending the aforementioned raw materials so that the blend has a desired composition, putting the blend in a crucible made of alumina or the like, and dissolving the blend in a vacuum of 1×10⁻² torr or lower, or in an inert-gas atmosphere by using a high-frequency melting furnace. Further, the present disclosure may include a step of casting the molten alloy by using a mold and thereby obtaining an alloy ingot. Alternatively, as a different method, a flaky alloy having a thickness of about 1 mm may be manufactured by dropping the molten alloy onto a copper roll (a strip casting method).

Further, in the case where the alloy ingot is obtained by the above-described casting, the alloy ingot may be heat-treated at a solution-treatment temperature for 1 to 20 hours. Note that the solution-treatment temperature for the alloy ingot may be adjusted as appropriate according to the composition and the like of the alloy.

Next, the alloy is pulverized into a powder. The method for pulverizing the alloy is not limited to any particular method, and may be selected as appropriate from known methods. As an example, the alloy ingot or the flake alloy is first coarsely pulverized to a size of about 100 to 500 μm by a known pulverizing machine, and then finely pulverized by a ball mill or a jet mill. Although the average grain size of the powder is not limited to any particular size, the alloy ingot or the flake alloy may be pulverized into a powder of which 60 mass % or larger has an average grain size of no smaller than 1 μm and no larger than 10 μm, or about 8 μm or smaller, or 6 μm or smaller so that the sintering time of the sintering step (which will be described later) can be shortened and a homogeneous permanent magnet can be manufactured.

Next, the obtained powder is pressure-molded, so that a molded body having a desired shape is obtained. In the manufacturing method according to the present disclosure, the obtained powder may be pressure-molded in a constant magnetic field in order to align the orientation of crystals of the powder and thereby to improve the magnetic properties thereof. There is no particular restriction on the relation between the direction of the magnetic field and the pressing direction, and they may be selected as appropriate according to the shape and the like of the product. For example, when a ring magnet or a thin plate-like magnet is manufactured, it is possible to use parallel magnetic-field pressing in which a magnetic field is applied in a direction parallel to the pressing direction. On the other hand, in order to achieve excellent magnetic properties, use right-angle magnetic-field pressing in which a magnetic field is applied at a right angle with respect to the pressing direction.

The magnitude of the magnetic field is not limited to any particular value, and the magnetic field may be, for example, a magnetic field of 15 kOe or weaker, or a magnetic field of 15 kOe or larger depending on the use and the like of the product. However, in order to achieve excellent magnetic properties, perform the pressure-molding in a magnetic field of 15 kOe or larger. Further, the pressure in the pressure molding may be adjusted as appropriate according to the size, the shape, and the like of the product. As an example, the pressure may be 0.5 to 2.0 ton/cm². That is, in the method for manufacturing the permanent magnet according to the present disclosure, in order to improve the magnetic properties, pressure-mold the powder in a magnetic field of 15 kOe or larger at a pressure of 0.5 to 2.0 ton/cm² or smaller which is applied perpendicularly to the magnetic field.

Next, the molded body is heated, so that a sintered compact is obtained. In this manufacturing method according to the present disclosure, the conditions for the sintering can be arbitrarily determined as long as the obtained sintered body is sufficiently densified. For example, known conditions may be used. In order to densify the sintered compact, the sintering temperature may be 1,170 to 1,215° C., or 1,180 to 1,205° C. By adjusting the temperature to 1,215° C. or lower, the rare-earth elements, particularly Sm, are prevented from evaporating, and hence a permanent magnet having excellent magnetic properties can be manufactured. Further, in the present disclosure, since the melting point tends to decrease because of the presence of Mn, the sintering can be sufficiently performed at 1,215° C. or lower.

Regarding the temperature-increasing conditions during the sintering step, in order to remove the adsorptive gas contained in the molded body, start vacuuming at a room temperature and increase the temperature at a rate of 1 to 10° C./min. In the temperature-increasing process, a hydrogen atmosphere may be used instead of performing the vacuuming. In some embodiments, the hydrogen atmosphere can be switched to the vacuum atmosphere in a temperature range of 1,150° C. or lower.

The sintering time may be 20 to 210 minutes, or 30 to 150 minutes in order to sufficiently densify the sintered compact while preventing Sm from evaporating. Further, in order to prevent the oxidation, the above-described sintering step may be performed in a vacuum of 1,000 Pa or lower or in an inert-gas atmosphere. Further, in order to increase the density of the sintered compact, the sintering step can be performed in a vacuum of 100 Pa or lower.

After the sintering, the temperature is decreased to the solution-treatment temperature and the solution treatment is carried out. In order to suppress the increase in the coefficient of variation (C. V.) of grain sizes of the crystal grains, the temperature decreasing rate up to the solution-treatment temperature may be 0.01 to 3° C./min.

The solution treatment is a step for forming a 1-7 phase (a TbCu₇-type structure), which is a precursor for the separation into a 2-17 phase and a 1-5 phase. In view of the homogenization, the solution temperature may be 1,110 to 1,165° C., or 1,120 to 1,160° C. Further, in view of the homogenization, the solution-treatment time may be 5 to 150 hours, or 10 to 100 hours. The solution treatment may be performed in a vacuum of 1,000 Pa or lower, or in an inert atmosphere.

After the solution treatment, rapidly cool the molded body to 600° C. or lower. The cooling rate of the rapid cooling may be 80° C./min or higher. The crystal structure of the 1-7 phase is maintained by performing the rapid cooling. Meanwhile, though depending on the shape of the molded body, the upper limit of the cooling rate may be, for example, 250° C./min or lower.

Next, after the rapid cooling step, the molded body is subjected to an aging process, so that a 2-17 phase and a 1-5 phase are formed. Although the aging temperature is not limited to any particular temperature, in order to obtain a permanent magnet containing the 2-17 phase as the main phase, and homogeneously (or uniformly) containing the 2-17 phase and the 1-5 phase, use a method in which the molded body is held at a temperature of 700 to 900° C. for 2 to 20 hours, and after that the cooling rate is set to 2° C./min or lower until the molded body is cooled to 400° C. or lower. By holding the molded body at the temperature of 700° C. to 900° C. for 2 to 20 hours, the 2-17 phase and the 1-5 phase can be homogeneously formed. In particular, the aging treatment may be performed in a temperature range of 800 to 850° C. Further, in order to obtain satisfactory magnetic properties, the cooling rate may be adjusted to 2° C./min or lower, or 0.5° C./min or lower.

According to the above-described manufacturing method, it is possible to obtain a permanent magnet containing a plurality of crystal grains and grain boundaries, in which the average crystal grain size (A. G.) of the crystal grains is equal to or larger than 100 μm, and the coefficient of variation (C. V.) of crystal grain sizes is equal to or smaller than 0.60.

### Device

The present disclosure can also provide a device including the above-described permanent magnet. Examples of such a device include clocks (watches), electric motors, various instruments, communication apparatuses, computer terminals, speakers, video discs, and sensors. Further, since the permanent magnet according to the present disclosure has a high residual magnetic flux density, a low coercive force, and a high squareness ratio as described above, it can be suitably applied to, among others, a variable magnetic-field motor, so that it is possible to obtain a variable magnetic-field motor capable of achieving high efficiency over a wide speed range from a low speed to a high speed.

### EXAMPLES

The present disclosure will be described hereinafter in a concrete manner by using examples and comparative examples. Note that the present disclosure is not limited by the descriptions of examples and the like below.

### Examples 1 to 3

Base alloys each containing 20% of Fe and 80% of Zr, and various raw materials were prepared (i.e., mixed) so that compositions of Examples 1 to 3 shown in the Table 1 were obtained. Then, they were dissolved by a high-frequency melting furnace, and the melt was cast into alloy ingots.

Each of the obtained base alloys was coarsely pulverized in an inert gas so that the average size became about 100 to 500 μm, and then finely pulverized into a powder in an inert gas by using a ball mill so that the average size became about 6 μm.

Molded bodies were obtained by pressing the powders in a magnetic field of 15 kOe with a pressure of 1 ton/cm².

Each of the molded body was sintered at 1,200° C. for 80 minutes in a vacuum lower than 1,000 Pa, and then a solution treatment was performed at 1,135° C. for 50 hours. Further, the molded body is rapidly cooled to 1,000 to 600° C. at a cooling rate of 80° C./min. After the rapid cooling, the molded body was held at 850° C. for 12 hours, and then was subjected to an aging process under a condition that the molded body was slowly cooled to 350° C. at a cooling rate of 0.5° C./min. Through these processes, a permanent magnet was obtained. The magnetic properties of each of the obtained permanent magnets were measured, and then the structure thereof was observed. For each of the obtained permanent magnets, the average crystal grain size (A. G.) of crystal grains, the coefficient of variation (C. V.) of crystal grain sizes, the density, Br, [BH]m, Hcj, Hk/Hcj, the temperature coefficient (α) of Br in a temperature range of 25 to 200° C., and the temperature coefficient (β) of Hcj in the temperature range of 25 to 200° C. were measured by the above-described methods. Table 1 shows the results of the measurements.

### Comparative Examples 1 and 2

Permanent magnets were obtained in the same manner as in the Examples 1 to 3 except that the compositions were changed to those for Comparative Examples 1 and 2 shown in Table 1. Table 1 shows the results of measurements of various physical properties in the same manner as in the Examples 1 to 3.

### Examples 4 to 6

Base alloys each containing 20% of Fe and 80% of Zr, and various raw materials were prepared (i.e., mixed) so that compositions of Examples 4 to 6 shown in the Table 2 were obtained. Then, they were dissolved by a high-frequency melting furnace, and the melt was cast into alloy ingots.

Each of the obtained base alloys was coarsely pulverized in an inert gas so that the average size became about 100 to 500 μm, and then finely pulverized into a powder in an inert gas by using a ball mill so that the average size became about 6 μm.

Molded bodies were obtained by pressing the powders in a magnetic field of 15 kOe with a pressure of 1 ton/cm².

Each of the molded body was sintered at its respective temperature shown in Table 2 for 180 minutes in a vacuum lower than 1,000 Pa, and then a solution treatment was performed at 1,130° C. for 30 hours. Further, the molded body is rapidly cooled to 1,000 to 600° C. at a cooling rate of 80° C./min. After the rapid cooling, the molded body was held at 850° C. for 12 hours, and then was subjected to an aging process under a condition that the molded body was slowly cooled to 350° C. at a cooling rate of 0.5° C./min. Through these processes, a permanent magnet was obtained. Table 2 shows the results of measurements of various physical properties in the same manner as in the Examples 1 to 3.

### Comparative Examples 3 to 4

Permanent magnets were obtained in the same manner as in the Examples 4 to 6 except that the sintering temperatures were changed to those for Comparative Examples 3 and 4 shown in Table 2. Table 2 shows the results of measurements of various physical properties in the same manner as in the Examples 1 to 3.

### Examples 7 to 9

Base alloys each containing 20% of Fe and 80% of Zr, and various raw materials were prepared (i.e., mixed) so that compositions of Examples 7 to 9 shown in the Table 3 were obtained. Then, they were dissolved by a high-frequency melting furnace, and the melt was cast into alloy ingots.

Each of the obtained base alloys was coarsely pulverized in an inert gas so that the average size became about 100 to 500 μm, and then finely pulverized into a powder in an inert gas by using a ball mill so that the average size became about 6 μm.

Molded bodies were obtained by pressing the powders in a magnetic field of 15 kOe with a pressure of 1 ton/cm².

Each of the molded body was sintered at 1,185° C. for its respective time period shown in Table 3 in a vacuum lower than 1,000 Pa, and then a solution treatment was performed at 1,125° C. for 100 hours. Further, the molded body is rapidly cooled to 1,000 to 600° C. at a cooling rate of 80° C./min. After the rapid cooling, the molded body was held at 850° C. for 12 hours, and then was subjected to an aging process under a condition that the molded body was slowly cooled to 350° C. at a cooling rate of 0.5° C./min. Through these processes, a permanent magnet was obtained. Table 3 shows the results of measurements of various physical properties in the same manner as in the Examples 1 to 3.

### Comparative Examples 5 to 6

Permanent magnets were obtained in the same manner as in the Examples 7 to 9 except that the sintering times were changed to those for Comparative Examples 5 and 6 shown in Table 3. Table 3 shows the results of measurements of various physical properties in the same manner as in the Examples 1 to 3.

### Examples 10 to 13

Base alloys each containing 20% of Fe and 80% of Zr, and various raw materials were prepared (i.e., mixed) so that compositions of Examples 10 to 13 shown in the Table 4 were obtained. Then, they were dissolved by a high-frequency melting furnace, and the melt was cast into alloy ingots.

Each of the obtained base alloys was coarsely pulverized in an inert gas so that the average size became about 100 to 500 μm, and then finely pulverized into a powder in an inert gas by using a ball mill so that the average size became about 6 μm.

Molded bodies were obtained by pressing the powders in a magnetic field of 15 kOe with a pressure of 1 ton/cm².

Each of the molded body was sintered at 1,190° C. for 150 minutes in a vacuum lower than 1,000 Pa, and then a solution treatment was performed at its respective temperature shown in Table 4 for 80 hours. Further, the molded body is rapidly cooled to 1,000 to 600° C. at a cooling rate of 80° C./min. After the rapid cooling, the molded body was held at 850° C. for 12 hours, and then was subjected to an aging process under a condition that the molded body was slowly cooled to 350° C. at a cooling rate of 0.5° C./min. Through these processes, a permanent magnet was obtained. Table 4 shows the results of measurements of various physical properties in the same manner as in the Examples 1 to 3.

### Comparative Examples 7 to 9

Permanent magnets were obtained in the same manner as in the Examples 10 to 13 except that the compositions and the solution-treatment temperatures were changed to those for Comparative Examples 7 and 9 shown in Table 4. Table 4 shows the results of measurements of various physical properties in the same manner as in the Examples 1 to 3.

### Examples 14 to 17

Base alloys each containing 20% of Fe and 80% of Zr, and various raw materials were prepared (i.e., mixed) so that compositions of Examples 14 to 17 shown in the Table 5 were obtained. Then, they were dissolved by a high-frequency melting furnace, and the melt was cast into alloy ingots.

Each of the obtained base alloys was coarsely pulverized in an inert gas so that the average size became about 100 to 500 μm, and then finely pulverized into a powder in an inert gas by using a ball mill so that the average size became about 6 μm.

Molded bodies were obtained by pressing the powders in a magnetic field of 15 kOe with a pressure of 1 ton/cm².

Each of the molded body was sintered at 1,205° C. for 100 minutes in a vacuum lower than 1,000 Pa, and then a solution treatment was performed at 1,145° C. for its respective time period shown in Table 5. Further, the molded body is rapidly cooled to 1,000 to 600° C. at a cooling rate of 80° C./min. After the rapid cooling, the molded body was held at 850° C. for 12 hours, and then was subjected to an aging process under a condition that the molded body was slowly cooled to 350° C. at a cooling rate of 0.5° C./min. Through these processes, a permanent magnet was obtained. Table 5 shows the results of measurements of various physical properties in the same manner as in the Examples 1 to 3.

### Comparative Examples 10 to 12

Permanent magnets were obtained in the same manner as in the Examples 14 to 17 except that the compositions and the solution-treatment times were changed to those for Comparative Examples 10 and 12 in Table 5. Table 5 shows the results of measurements of various physical properties in the same manner as in the Examples 1 to 3.

### Example 18

A base alloy containing 20% of Fe and 80% of Zr, and various raw materials were prepared (i.e., mixed) so that a composition of an Example 18 shown in the Table 6 was obtained. Then, it was dissolved by a high-frequency melting furnace, and the melt was cast into an alloy ingot.

The obtained base alloy was coarsely pulverized in an inert gas so that the average size became about 100 to 500 μm, and then finely pulverized into a powder in an inert gas by using a ball mill so that the average size became about 6 μm.

A molded body was obtained by pressing the powder in a magnetic field of 15 kOe with a pressure of 1 ton/cm².

The molded body was sintered at 1,210° C. for 120 minutes in a vacuum lower than 1,000 Pa, and then a solution treatment was performed at 1,150° C. for 60 hours. Further, the molded body is rapidly cooled to 1,000 to 600° C. at a cooling rate of 80° C./min. After the rapid cooling, the molded body was held at 850° C. for 12 hours, and then was subjected to an aging process under a condition that the molded body was slowly cooled to 350° C. at a cooling rate of 0.5° C./min. Through these processes, a permanent magnet was obtained. Table 6 shows the results of measurements of various physical properties in the same manner as in the Examples 1 to 3.

### Comparative Examples 13 to 17

Permanent magnets were obtained in the same manner as in the Example 18 except that the compositions were changed to those for Comparative Examples 13 and 17 shown in Table 6. Table 6 shows the results of measurements of various physical properties in the same manner as in the Examples 1 to 3.

### Example 19

A base alloy containing 20% of Fe and 80% of Zr, and various raw materials were prepared (i.e., mixed) so that a composition of an Example 19 shown in the Table 7 was obtained. Then, it was dissolved by a high-frequency melting furnace, and the melt was cast into an alloy ingot.

The obtained base alloy was coarsely pulverized in an inert gas so that the average size became about 100 to 500 μm, and then finely pulverized into a powder in an inert gas by using a ball mill so that the average size became about 6 μm.

A molded body was obtained by pressing the powder in a magnetic field of 15 kOe with a pressure of 1 ton/cm².

The molded body was sintered at 1,195° C. for 135 minutes in a vacuum lower than 1,000 Pa, and then a solution treatment was performed at 1,140° C. for 75 hours. Further, the molded body is rapidly cooled to 1,000 to 600° C. at a cooling rate of 80° C./min. After the rapid cooling, the molded body was held at 850° C. for 12 hours, and then was subjected to an aging process under a condition that the molded body was slowly cooled to 350° C. at a cooling rate of 0.5° C./min. Through these processes, a permanent magnet was obtained. Table 7 shows the results of measurements of various physical properties in the same manner as in the Examples 1 to 3.

### Comparative Examples 18 to 20

Permanent magnets were obtained in the same manner as in the Example 19 except that the compositions were changed to those for Comparative Examples 18 and 20 shown in Table 7. Table 7 shows the results of measurements of various physical properties in the same manner as in the Examples 1 to 3.

TABLE 1
Table 1 (Mn is changed)

| | | | | Solution | Solution |
|---|---|---|---|---|---|
| | | Sintering | Sintering | Treatment | Treatment |
| | | Temperature | Time | Temperature | Time |
| | Compositon | [° C.] | [min] | [° C.] | [h] |
| Exampl 1 | Sm_{25.0}Fe_{23.5}Cu_{4.65}Zr_{2.15}Mn_{0.01}Co_{bal} | 1200 | 80 | 1135 | 50 |
| Exampl 2 | Sm_{25.0}Fe_{23.5}Cu_{4.65}Zr_{2.15}Mn_{1.25}Co_{bal} | 1200 | 80 | 1135 | 50 |
| Exampl 3 | Sm_{25.0}Fe_{23.5}Cu_{4.65}Zr_{2.15}Mn_{2.50}Co_{bal} | 1200 | 80 | 1135 | 50 |
| Comparative | Sm_{25.0}Fe_{23.5}Cu_{4.65}Zr_{2.15}Mn_{3.00}Co_{bal} | 1200 | 80 | 1135 | 50 |
| Exampl 1 | | | | | |
| Comparative | Sm_{25.0}Fe_{23.5}Cu_{4.65}Zr_{2.15}Co_{bal} | 1200 | 80 | 1135 | 50 |
| Exampl 2 | | | | | |

| | A.G. | | Density | Br | [BH]m | Hcj | Hk/Hcj | α | β |
|---|---|---|---|---|---|---|---|---|---|
| | [μm] | C.V. | [g/cm³] | [T] | [kJ/m³] | [kA/m] | [%] | [%/° C.] | [%/° C.] |
| Exampl 1 | 175 | 0.20 | 8.33 | 1.22 | 275 | 2220 | 73 | 0.035 | 0.30 |
| Exampl 2 | 210 | 0.40 | 8.30 | 1.20 | 265 | 2000 | 78 | 0.040 | 0.32 |
| Exampl 3 | 125 | 0.50 | 8.25 | 1.18 | 260 | 1750 | 66 | 0.045 | 0.34 |
| Comparative | 90 | 0.55 | 8.23 | 1.15 | 255 | 1570 | 60 | 0.055 | 0.37 |
| Exampl 1 | | | | | | | | | |
| Comparative | 95 | 0.55 | 8.23 | 1.15 | 255 | 1570 | 60 | 0.055 | 0.37 |
| Exampl 2 | | | | | | | | | |

TABLE 2
Table 2 (Sintering tempeture is changed)

| | | | | Solution | Solution |
|---|---|---|---|---|---|
| | | Sintering | Sintering | Treatment | Treatment |
| | | Temperature | Time | Temperature | Time |
| | Compositon | [° C.] | [min] | [° C.] | [h] |
| Exampl 4 | Sm_{23.0}Fe_{22.0}Cu_{5.00}Zr_{2.50}Mn_{1.00}Co_{bal} | 1175 | 180 | 1130 | 30 |
| Exampl 5 | Sm_{23.0}Fe_{22.0}Cu_{5.00}Zr_{2.50}Mn_{1.00}Co_{bal} | 1195 | 180 | 1130 | 30 |
| Exampl 6 | Sm_{23.0}Fe_{22.0}Cu_{5.00}Zr_{2.50}Mn_{1.00}Co_{bal} | 1215 | 180 | 1130 | 30 |
| Comparative | Sm_{23.0}Fe_{22.0}Cu_{5.00}Zr_{2.50}Mn_{1.00}Co_{bal} | 1155 | 180 | 1130 | 30 |
| Exampl 3 | | | | | |
| Comparative | Sm_{23.0}Fe_{22.0}Cu_{5.00}Zr_{2.50}Mn_{1.00}Co_{bal} | 1235 | 180 | 1130 | 30 |
| Exampl 4 | | | | | |

| | A.G. | | Density | Br | [BH]m | Hcj | Hk/Hcj | α | β |
|---|---|---|---|---|---|---|---|---|---|
| | [μm] | C.V. | [g/cm³] | [T] | [kJ/m³] | [kA/m] | [%] | [%/° C.] | [%/° C.] |
| Exampl 4 | 160 | 0.35 | 8.28 | 1.18 | 270 | 1965 | 75 | 0.045 | 0.28 |
| Exampl 5 | 180 | 0.30 | 8.31 | 1.21 | 280 | 1825 | 81 | 0.037 | 0.27 |
| Exampl 6 | 205 | 0.45 | 8.33 | 1.20 | 275 | 1665 | 67 | 0.050 | 0.35 |
| Comparative | 90 | 0.60 | 8.17 | 1.15 | 245 | 1400 | 60 | 0.052 | 0.38 |
| Exampl 3 | | | | | | | | | |
| Comparative | 160 | 0.70 | 8.33 | 1.15 | 220 | 1155 | 45 | 0.057 | 0.45 |
| Exampl 4 | | | | | | | | | |

TABLE 3
Table 3 (Sintering time is changed)

| | | | | Solution | Solution |
|---|---|---|---|---|---|
| | | Sintering | Sintering | Treatment | Treatment |
| | | Temperature | Time | Temperature | Time |
| | Compositon | [° C.] | [min] | [° C.] | [h] |
| Exampl 7 | Sm_{24.0}Fe_{27.0}Cu_{4.00}Zr_{2.35}Mn_{2.00}Co_{bal} | 1185 | 20 | 1125 | 100 |
| Exampl 8 | Sm_{24.0}Fe_{27.0}Cu_{4.00}Zr_{2.35}Mn_{2.00}Co_{bal} | 1185 | 100 | 1125 | 100 |
| Exampl 9 | Sm_{24.0}Fe_{27.0}Cu_{4.00}Zr_{2.35}Mn_{2.00}Co_{bal} | 1185 | 210 | 1125 | 100 |
| Comparative | Sm_{24.0}Fe_{27.0}Cu_{4.00}Zr_{2.35}Mn_{2.00}Co_{bal} | 1185 | 10 | 1125 | 100 |
| Exampl 5 | | | | | |
| Comparative | Sm_{24.0}Fe_{27.0}Cu_{4.00}Zr_{2.35}Mn_{2.00}Co_{bal} | 1185 | 250 | 1125 | 100 |
| Exampl 6 | | | | | |

| | A.G. | | Density | Br | [BH]m | Hcj | Hk/Hcj | α | β |
|---|---|---|---|---|---|---|---|---|---|
| | [μm] | C.V. | [g/cm³] | [T] | [kJ/m³] | [kA/m] | [%] | [%/° C.] | [%/° C.] |
| Exampl 7 | 107 | 0.33 | 8.25 | 1.20 | 261 | 1600 | 72 | 0.047 | 0.32 |
| Exampl 8 | 181 | 0.41 | 8.30 | 1.22 | 278 | 1710 | 77 | 0.044 | 0.31 |
| Exampl 9 | 212 | 0.46 | 8.31 | 1.22 | 276 | 1630 | 68 | 0.050 | 0.34 |
| Comparative | 91 | 0.30 | 8.20 | 1.19 | 254 | 1480 | 64 | 0.051 | 0.39 |
| Exampl 5 | | | | | | | | | |
| Comparative | 214 | 0.65 | 8.31 | 1.21 | 269 | 1575 | 63 | 0.053 | 0.40 |
| Exampl 6 | | | | | | | | | |

TABLE 4
Table 4 (Solution treatment temperature is changed)

| | | | | Solution | Solution |
|---|---|---|---|---|---|
| | | Sintering | Sintering | Treatment | Treatment |
| | | Temperature | Time | Temperature | Time |
| | Compositon | [° C.] | [min] | [° C.] | [h] |
| Exampl 10 | Sm_{27.0}Fe_{24.5}Cu_{4.40}Zr_{1.70}Mn_{1.50}Co_{bal} | 1190 | 150 | 1110 | 80 |
| Exampl 11 | Sm_{27.0}Fe_{24.5}Cu_{4.40}Zr_{1.70}Mn_{1.50}Co_{bal} | 1190 | 150 | 1140 | 80 |
| Exampl 12 | Sm_{27.0}Fe_{24.5}Cu_{4.40}Zr_{1.70}Mn_{1.50}Co_{bal} | 1190 | 150 | 1165 | 80 |
| Exampl 13 | Sm_{25.5}Nd_{1.5}Fe_{24.5}Cu_{4.40}Zr_{1.70}Mn_{1.50}Co_{bal} | 1190 | 150 | 1140 | 80 |
| Comparative | Sm_{27.0}Fe_{24.5}Cu_{4.40}Zr_{1.70}Mn_{1.50}Co_{bal} | 1190 | 150 | 1100 | 80 |
| Exampl 7 | | | | | |
| Comparative | Sm_{27.0}Fe_{24.5}Cu_{4.40}Zr_{1.70}Mn_{1.50}Co_{bal} | 1190 | 150 | 1175 | 80 |
| Exampl 8 | | | | | |
| Comparative | Sm_{25.5}Nd_{1.5}Fe_{24.5}Cu_{4.40}Zr_{1.70}Mn_{1.50}Co_{bal} | 1190 | 150 | 1100 | 80 |
| Exampl 9 | | | | | |

| | A.G. | | Density | Br | [B H]m | Hcj | Hk/Hcj | α | β |
|---|---|---|---|---|---|---|---|---|---|
| | [μm] | C.V. | [g/cm³] | [T] | [kJ/m³] | [kA/m] | [%] | [%/° C.] | [%/° C.] |
| Exampl 10 | 133 | 0.51 | 8.26 | 1.16 | 266 | 1605 | 65 | 0.049 | 0.33 |
| Exampl 11 | 155 | 0.43 | 8.29 | 1.19 | 270 | 1730 | 71 | 0.043 | 0.30 |
| Exampl 12 | 171 | 0.56 | 8.30 | 1.20 | 275 | 1770 | 75 | 0.039 | 0.29 |
| Exampl 13 | 208 | 0.36 | 8.28 | 1.22 | 277 | 1610 | 73 | 0.040 | 0.28 |
| Comparative | 96 | 0.61 | 8.24 | 1.15 | 254 | 1450 | 62 | 0.052 | 0.36 |
| Exampl 7 | | | | | | | | | |
| Comparative | 105 | 0.62 | 8.31 | 1.19 | 257 | 1530 | 64 | 0.054 | 0.37 |
| Exampl 8 | | | | | | | | | |
| Comparative | 97 | 0.63 | 8.24 | 1.15 | 259 | 1380 | 60 | 0.055 | 0.38 |
| Exampl 9 | | | | | | | | | |

TABLE 5
Table 5 (Solution treatment time is changed)

| | | | | Solution | Solution |
|---|---|---|---|---|---|
| | | Sintering | Sintering | Treatment | Treatment |
| | | Temperature | Time | Temperature | Time |
| | Compositon | [° C.] | [min] | [° C.] | [h] |
| Exampl 14 | Sm_{26.0}Fe_{25.0}Cu_{4.85}Zr_{2.00}Mn_{0.50}Co_{bal} | 1205 | 100 | 1145 | 5 |
| Exampl 15 | Sm_{26.0}Fe_{25.0}Cu_{4.85}Zr_{2.00}Mn_{0.50}Co_{bal} | 1205 | 100 | 1145 | 80 |
| Exampl 16 | Sm_{26.0}Fe_{25.0}Cu_{4.85}Zr_{2.00}Mn_{0.50}Co_{bal} | 1205 | 100 | 1145 | 150 |
| Exampl 17 | Sm_{25.5}Pr_{0.5}Fe_{25.0}Cu_{4.85}Zr_{2.00}Mn_{0.5}Co_{bal} | 1205 | 100 | 1145 | 80 |
| Comparative | Sm_{26.0}Fe_{25.0}Cu_{4.85}Zr_{2.00}Mn_{0.50}Co_{bal} | 1205 | 100 | 1145 | 3 |
| Exampl 10 | | | | | |
| Comparative | Sm_{26.0}Fe_{25.0}Cu_{4.85}Zr_{2.00}Mn_{0.50}Co_{bal} | 1205 | 100 | 1145 | 200 |
| Exampl 11 | | | | | |
| Comparative | Sm_{25.5}Pr_{0.5}Fe_{25.0}Cu_{4.85}Zr_{2.00}Mn_{0.50}Co_{bal} | 1205 | 100 | 1145 | 3 |
| Exampl 12 | | | | | |

| | A.G. | | Density | Br | [BH]m | Hcj | Hk/Hcj | α | β |
|---|---|---|---|---|---|---|---|---|---|
| | [μm] | C.V. | [g/cm³] | [T] | [kJ/m³] | [kA/m] | [%] | [%/° C.] | [%/° C.] |
| Exampl 14 | 105 | 0.54 | 8.30 | 1.17 | 261 | 1640 | 68 | 0.050 | 0.35 |
| Exampl 15 | 140 | 0.48 | 8.31 | 1.18 | 265 | 1705 | 77 | 0.042 | 0.30 |
| Exampl 16 | 155 | 0.58 | 8.32 | 1.19 | 268 | 1735 | 80 | 0.043 | 0.28 |
| Exampl 17 | 161 | 0.58 | 8.27 | 1.20 | 269 | 1625 | 78 | 0.039 | 0.32 |
| Comparative | 98 | 0.61 | 8.23 | 1.15 | 252 | 1595 | 61 | 0.055 | 0.39 |
| Exampl 10 | | | | | | | | | |
| Comparative | 157 | 0.66 | 8.29 | 1.17 | 259 | 1560 | 71 | 0.051 | 0.36 |
| Exampl 11 | | | | | | | | | |
| Comparative | 99 | 0.67 | 8.22 | 1.15 | 248 | 1495 | 54 | 0.058 | 0.42 |
| Exampl 12 | | | | | | | | | |

TABLE 6
Table 6 (Outside of compositon & Deterioration of properties)

| | | | | Solution | Solution |
|---|---|---|---|---|---|
| | | Sintering | Sintering | Treatment | Treatment |
| | | Temperature | Time | Temperature | Time |
| | Compositon | [° C.] | [min] | [° C.] | [h] |
| Exampl 18 | Sm_{25.0}Fe_{24.5}Cu_{4.50}Zr_{2.10}Mn_{1.25}Co_{bal} | 1210 | 120 | 1150 | 60 |
| Comparative | Sm_{22.5}Fe_{24.5}Cu_{4.50}Zr_{2.10}Mn_{1.25}Co_{bal} | 1210 | 120 | 1150 | 60 |
| Exampl 13 | | | | | |
| Comparative | Sm_{27.5}Fe_{24.5}Cu_{4.50}Zr_{2.10}Mn_{1.25}Co_{bal} | 1210 | 120 | 1150 | 60 |
| Exampl 14 | | | | | |
| Comparative | Sm_{25.0}Fe_{21.5}Cu_{4.50}Zr_{2.10}Mn_{1.25}Co_{bal} | 1210 | 120 | 1150 | 60 |
| Exampl 15 | | | | | |
| Comparative | Sm_{25.0}Fe_{27.5}Cu_{4.50}Zr_{2.10}Mn_{1.25}Co_{bal} | 1210 | 120 | 1150 | 60 |
| Exampl 16 | | | | | |
| Comparative | Sm_{25.0}Fe_{24.5}Cu_{4.50}Zr_{2.10}Mn_{2.55}Co_{bal} | 1210 | 120 | 1150 | 60 |
| Exampl 17 | | | | | |

| | A.G. | | Density | Br | [BH]m | Hcj | Hk/Hcj | α | β |
|---|---|---|---|---|---|---|---|---|---|
| | [μm] | C.V. | [g/cm³] | [T] | [kJ/m³] | [kA/m] | [%] | [%/° C.] | [%/° C.] |
| Exampl 18 | 157 | 0.41 | 8.31 | 1.22 | 273 | 1615 | 75 | 0.037 | 0.28 |
| Comparative | 142 | 0.36 | 8.32 | 1.21 | 258 | 1375 | 57 | 0.039 | 0.36 |
| Exampl 13 | | | | | | | | | |
| Comparative | 151 | 0.52 | 8.33 | 1.20 | 259 | 1350 | 55 | 0.048 | 0.37 |
| Exampl 14 | | | | | | | | | |
| Comparative | 125 | 0.45 | 8.36 | 1.15 | 253 | 1540 | 63 | 0.043 | 0.30 |
| Exampl 15 | | | | | | | | | |
| Comparative | 174 | 0.58 | 8.29 | 1.24 | 254 | 1545 | 44 | 0.053 | 0.38 |
| Exampl 16 | | | | | | | | | |
| Comparative | 118 | 0.33 | 8.33 | 1.20 | 255 | 1580 | 60 | 0.040 | 0.30 |
| Exampl 17 | | | | | | | | | |

TABLE 7
Table 7 (Outside of compositon & Abnormal form of clystal grains)

| | | | | Solution | Solution |
|---|---|---|---|---|---|
| | | Sintering | Sintering | Treatment | Treatment |
| | | Temperature | Time | Temperature | Time |
| | Compositon | [° C.] | [min] | [° C.] | [h] |
| Exampl 19 | Sm_{24.5}Fe_{25.0}Cu_{4.60}Zr_{2.05}Mn_{1.00}Co_{bal} | 1195 | 135 | 1140 | 75 |
| Comparative | Sm_{22.5}Fe_{25.0}Cu_{4.60}Zr_{2.05}Mn_{1.00}Co_{bal} | 1195 | 135 | 1140 | 75 |
| Exampl 18 | | | | | |
| Comparative | Sm_{24.5}Fe_{27.5}Cu_{4.60}Zr_{2.05}Mn_{1.00}Co_{bal} | 1195 | 135 | 1140 | 75 |
| Exampl 19 | | | | | |
| Comparative | Sm_{24.5}Fe_{25.0}Cu_{4.60}Zr_{2.05}Mn_{2.55}Co_{bal} | 1195 | 135 | 1140 | 75 |
| Exampl 20 | | | | | |

| | A.G. | | Density | Br | [BH]m | Hcj | Hk/Hcj | α | β |
|---|---|---|---|---|---|---|---|---|---|
| | [μm] | C.V. | [g/cm³] | [T] | [kJ/m³] | [kA/m] | [%] | [%/° C.] | [%/° C.] |
| Exampl 19 | 145 | 0.40 | 8.33 | 1.22 | 268 | 1615 | 73 | 0.047 | 0.27 |
| Comparative | 93 | 0.35 | 8.30 | 1.21 | 254 | 1595 | 61 | 0.039 | 0.32 |
| Exampl 18 | | | | | | | | | |
| Comparative | 90 | 0.38 | 8.26 | 1.16 | 246 | 1360 | 45 | 0.052 | 0.38 |
| Exampl 19 | | | | | | | | | |
| Comparative | 150 | 0.61 | 8.30 | 1.18 | 260 | 1550 | 65 | 0.050 | 0.36 |
| Exampl 20 | | | | | | | | | |

As shown in Tables 1 to 7, it has been shown that, by manufacturing the permanent magnets of the Examples 1 to 19 each of which contains Mn and has a predetermined composition under appropriate heat treatment conditions, the grain sizes of crystal grains satisfy conditions “A. G≥100 μm” and “C. V.≤0.60”. Further, it has been shown that each of the permanent magnets of the Examples 1 to 19 satisfies conditions “Density≥8.25 g/cm³”, “Br≥1.16 T”, “[BH]m≥260 kJ/m³”, “Hcj≥1600 A/m”, “Hk/Hcj≥65%”, “α≤0.050%/° C.”, and “β≤0.40/° C.”, so that these permanent magnets have excellent magnetic properties.

On the other hand, in each of the permanent magnets of the Comparative Examples 1 to 12 and the Comparative Examples 18 to 20, in each of which the composition is out of the range or the heat treatment conditions are not appropriate, at least one of A. G and C. V. differs from those in the present disclosure, and at least one of the density, Br, [BH]m, Hcj, Hk/Hcj, α, and β is poorer than those of the examples according to the present disclosure. Further, it has been shown that each of the permanent magnets of the Comparative Examples 13 to 17, in each of which the composition is out of the range according to the present disclosure, has magnetic properties poorer than those of the permanent magnets according to the present disclosure even though their grain sizes of crystal grains are within the appropriate range.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the disclosure described herein.

1. A permanent magnet consisting of a sintered compact having a composition consisting of, in a mass percentage composition, R: 23 to 27% (R is a rare-earth element including at least Sm); Fe: 22 to 27%; Mn: 0.01 to 2.5%; and a remainder consisting of Co and unavoidable impurities, wherein
the sintered compact contains a plurality of crystal grains and grain boundaries,
an average crystal grain size (A. G.) of the crystal grains is equal to or larger than 100 μm, and
a coefficient of variation (C. V.) of crystal grain sizes is equal to or smaller than 0.60.

2. The permanent magnet according to claim 1, further containing, in the mass percentage composition, Cu: 4.0 to 5.0%, and Zr: 1.7 to 2.5%.

3. The permanent magnet according to claim 1, wherein
when a coercive force is represented by Hcj and a magnitude of a reverse magnetic field when a residual magnetic flux density (Br) is 90% is represented by Hk, a squareness ratio (Hk/Hcj) is equal to or higher than 65% under conditions that: a density of the sintered compact is equal to or larger than 8.25 g/cm³; the residual magnetic flux density (Br) is equal to or larger than 1.16 T; and a maximum energy product (BH)m is equal to or larger than 260 kJ/m³, and
when a temperature coefficient of the residual magnetic flux density (Br) is represented by α and a temperature coefficient of the coercive force (Hcj) is represented by β, they satisfy conditions “α≤0.050%/K” and “β≤0.35%/K” in a temperature range of 25 to 200° C.

4. A device comprising a permanent magnet according to claim 1.
